(19) United States
(12) Patent Application Publication
(10) Pub. No.: US 2026/0208108 A1
(43) Pub. Date: Jul. 23, 2026

(54) METHOD OF CAPTURING CO2 FROM A GAS MIXTURE

(71) Applicant: Mission Zero Technologies Ltd, Epping Essex (GB)

(72) Inventors: Gael GOBAILLE-SHAW, Epping Essex (GB); Constantin SAHM, Epping Essex (GB); Audrey LUIZ, Epping Essex (GB); Trishan SHARMA, Epping Essex (GB)

(21) Appl. No.: 19/142,567

(22) PCT Filed: Dec. 22, 2023
(86) PCT No.: PCT/EP2023/087759

§ 371 Date: Jun. 23, 2025

(30) Foreign Application Priority Data
Dec. 23, 2022 (GB) 2219726.3

(51) Int. Cl. B01D 53/96; B01D 53/62; B01D 53/78; B01D 61/42; B01D 61/44; B01D 61/46

(52) U.S. Cl. CPC B01D 53/965; B01D 53/62; B01D 53/78; B01D 61/422; B01D 61/445; B01D 61/461; B01D 2251/306; B01D 2251/606; B01D 2252/10; B01D 2252/602; B01D 2257/504; B01D 2258/06

(57) ABSTRACT

Method of capturing CO₂ from a gas mixture (108) comprising the steps of: contacting the gas mixture (108) with a capture solution (110); dissolving CO₂ in the capture solution to form a modified capture solution comprising bicarbonate ions; performing electrodialysis on the modified capture solution using a bipolar membrane electrodialysis system (104) to transfer bicarbonate ions into a release solution (121) and regenerate the capture solution; wherein the capture solution comprises a metal carbonate, and wherein the capture solution contacts or comprises a promoter which accelerates the rate of bicarbonate formation in the capture solution.

### FIELD OF THE INVENTION

This invention relates to a method of capturing CO₂ from a gas mixture, in particular a method of capturing CO₂ directly from air.

### BACKGROUND

The capture of polluting gas species for storage or conversion to less harmful compounds is of growing environmental and economic importance worldwide. In particular, the capture of CO₂ from the air, also known as direct air capture or DAC, is a process that is highly desirable for a variety of environmental and economic reasons. Other than biological processes, direct air capture represents the only way to address polluting gas emissions of the past.

Of particular interest is direct air capture (DAC) of CO₂. Direct air capture of carbon species has potential for helping to fulfil industrial and national Net-Zero carbon emissions targets in the 21st century, especially in circumstances where traditional carbon capture technologies removing CO₂ from concentrated sources such as flue gas are unable to be deployed.

The current state of the art in direct air capture generally depends on two types of processes. In one implementation of DAC, CO₂ is absorbed by a highly caustic solution of hydroxide to form a precipitated carbonate. The carbonate is then heated to 800° C. until it decomposes to form CO₂ and to regenerate the caustic solution. The other implementation of DAC technology involves the adsorption of CO₂ into solid filters impregnated with amine groups. The amine groups bind CO₂ at ambient temperature and release it at elevated temperatures of around 100° C.

These techniques employ chemical processes that are extremely energy intensive and reliant on direct and/or indirect high-grade thermal energy, meaning that while the fundamentals of the processes do work, the economics of these technologies have so far proven too uncertain and unfavourable for extensive practical deployment. Inventions in this field that are the state-of-the-art are known to require between 1500-2500 kWh of energy per ton of CO₂ captured from air, compared to the fundamental thermodynamic minimum figure of 117 kWh/ton. This clearly demonstrates that much more efficient technologies must be invented to reduce energy consumption and thus reduce the economic costs of these processes.

The thermal demands of these prior art techniques also offset their environmental benefits, as the CO₂ emitted to produce the energy needed to power the DAC processes means that the actual net quantities of CO₂ capture achieved are lower than may be presumed at first glance. Certain commercialized DAC technologies require temperatures exceeding 600° C. for major sub-processes; presently they are only able to obtain heat at these temperatures through the combustion of natural gas, which is a fossil fuel with a significant CO₂ footprint itself. In other DAC technologies, high-grade pressurized steam is required for major sub-processes which is also sometimes sourced from fossil fuel combustion processes or locations with geo-thermal energy.

In some cases, prior art DAC processes are operable only in a batch or semi-batch mode as opposed to continuous operation, severely limiting the practical usefulness and the economics of these inventions. Given the already prohibitive capital cost of these technologies which currently exhibit levelized costs of $200-750/ton of CO₂, the downtimes incurred through batch/semi-batch operation constitute additional drawbacks and signal the need for newer technologies to be invented for DAC that overcome these constraints.

### SUMMARY OF THE INVENTION

The invention is defined in the appended independent claims, to which reference should now be made. Preferred features of the invention are set out in the dependent claims.

In a first aspect, the invention provides a method of capturing CO₂ from a gas mixture comprising the steps of:
contacting the gas mixture with a capture solution;
dissolving the target species in the capture solution to form a modified capture solution comprising bicarbonate ions;
performing electrodialysis on the modified capture solution using a bipolar membrane electrodialysis system, to transfer bicarbonate ions into a release solution and regenerate the capture solution;
wherein the capture solution comprises a metal carbonate, and wherein the capture solution contacts or comprises a promoter which accelerates the rate of bicarbonate formation in the capture solution.

The capture solution preferably comprises the promoter. In a preferred embodiment, the promoter is dissolved in the capture solution. Alternatively, the promoter may be immobilised on a promoter-functionalised surface, and the capture solution may be brought into contact with the promoter-functionalised surface. The promoter-functionalised surface may be a surface in a gas-liquid contactor, or a surface of an promoter-functionalised sorbent. The capture solution may be in contact with the promoter during the step of contacting the gas mixture with the capture solution, for example. Alternatively, the capture solution may be brought into contact with the promoter after the step of contacting the gas mixture with the capture solution, such that the promoter accelerates the conversion of dissolved CO₂ into bicarbonate anions to form the modified capture solution.

The promoter may be an inorganic promoter or an enzymatic promoter.

Preferably, the promoter may be an organic promoter. In a particularly preferred embodiment, the promoter may be an amine, or an amino acids.

The promoter is an additive which accelerates the rate of CO₂ hydration to form bicarbonate, relative to the same process carried out without the promoter.

The invention will be described below in the context of an amine promoter. The skilled person will appreciate, however, that the features of the second aspect may be applicable also to non-amine promoters covered by the first aspect of the invention.

In a second aspect, the invention provides a method of capturing CO₂ from a gas mixture comprising the steps of:
contacting the gas mixture with a capture solution;
dissolving CO₂ in the capture solution to form a modified capture solution comprising bicarbonate ions;
performing electrodialysis on the modified capture solution using a bipolar membrane electrodialysis system, to transfer bicarbonate ions into a release solution and regenerate the capture solution;
wherein the capture solution comprises a metal carbonate, and wherein the capture solution contacts or comprises an amine.

The amine advantageously acts as a promoter which accelerates the rate of bicarbonate formation in the capture solution.

The step of contacting the gas mixture with a capture solution may be performed in a variety of known methods, for example by bubbling a gaseous stream through the liquid capture solution, or by flowing the gas through a gas-liquid contactor. This step may be performed by directing the gas mixture through a packed column gas-liquid contactor which is configured to bring the gas into contact with the capture solution. In a preferred embodiment, this step is preferably performed by directing the gas mixture through a high surface area packing material supported by a large gas contacting structure which is configured to bring the gas into contact with the capture solution. Particularly preferably the gas-contacting structure is configured to bring the gas into contact with the capture solution in high volumes, preferably with a low pressure drop across the gas-contacting structure, for example less than 300 Pa, or less than 250 Pa, or less than 225 Pa.

The capture solution preferably comprises an amine. In a preferred embodiment, the amine is dissolved in the capture solution. Alternatively, the amine may be immobilised on an amine-functionalised surface, and the capture solution may be brought into contact with the amine-functionalised surface. The amine-functionalised surface may be a surface in a gas-liquid contactor, or a surface of an amine-functionalised sorbent. The capture solution may be in contact with the amine during the step of contacting the gas mixture with the capture solution, for example. Alternatively, the capture solution may be brought into contact with the amine after the step of contacting the gas mixture with the capture solution, such that the amine accelerates the conversion of dissolved CO₂ into bicarbonate anions to form the modified capture solution.

For the purposes of illustration, the following description will refer to the preferred embodiment in which the amine is dissolved in the capture solution.

As the gas mixture contacts the capture solution, gaseous CO₂ contained in the gas mixture is dissolved into the liquid phase of the capture solution, forming a modified capture solution. The dissolved CO₂ dissociates into negatively charged bicarbonate (HCO₃⁻) anions and carbonate (CO₃²⁻) anions, such that the modified capture solution is enriched in bicarbonate and carbonate anions relative to the capture solution prior to the gas contacting step.

Electrodialysis is performed on the modified capture solution using a bipolar membrane electrodialysis system, to transfer bicarbonate ions into a release solution and regenerate the capture solution.

A bipolar membrane electrodialysis (BMPED) system comprises an electrodialysis cell containing at least one bipolar membrane (BPM) which is configured to split water into H⁺ and OH ions, and at least one ion-exchange membrane which is configured to separate the release solution from the capture solution. The ion-exchange membrane may be a cation-exchange membrane (CEM), but in preferred embodiments of the present invention the BPMED cell contains at least one anion-exchange membrane (AEM) configured to allow passage of bicarbonate anions therethrough.

A variety of BPMED cell configurations can be used with the present invention, and the size of the cell, the separation between membranes, and the number of membrane pairs can be varied according to the requirements of individual systems.

In a preferred embodiment, the BPMED electrodialysis cell has a BPM-AEM-BPM configuration and comprises a basic compartment positioned between a first bipolar membrane and an anion-exchange membrane, and an acidic compartment positioned between the other side of the anion-exchange membrane and a second bipolar membrane. Electrodes are positioned outside the two outermost bipolar membranes and configured to apply an electrical potential across the electrodialysis chamber. The bipolar membrane electrodialysis system is preferably configured so that capture solution containing bicarbonate anions is circulated between the basic compartment and the gas contactor, while the release solution is circulated between the acidic compartment and a release vessel.

In use, modified capture solution containing carbonate and bicarbonate anions is fed into the basic compartment, while the first bipolar membrane splits water and feeds OH-ions into the modified capture solution in the basic compartment. Under the electric field in the electrodialysis chamber, carbonate CO₃²⁻ and bicarbonate HCO₃ ions are separated from the modified capture solution and transported through the anion-exchange membrane into the release solution in the acidic compartment of the electrodialysis chamber. The second bipolar membrane injects H⁺ ions into the release solution in the acidic compartment, which react with the carbonate bicarbonate ions to form H₂O and CO₂.

Bicarbonate (HCO₃) anions require only one hydrogen cation (H⁺) to form H₂O and CO₂, while carbonate (CO₃²⁻) anions require two hydrogen cations (H⁺) to form H₂O and CO₂. This means that the conversion of bicarbonate anions to CO₂ requires only half the electrical input compared to the conversion of carbonate to CO₂. By improving the selectivity of bicarbonate formation over carbonate formation in the modified capture solution, and/or improving the selectivity of bicarbonate transport into the release solution, the present invention aims to improve the efficiency of CO₂ capture and release.

Existing BPMED attempts at CO₂ capture in the prior art have used KOH as the capture solution, so that the dissolved CO₂ forms K₂CO₃ that is then separated by BPMED to regenerate the KOH capture solution. This approach suffers from problems, however, as high concentrations of KOH are required, which makes the capture solution very aggressive on membranes, and as KOH approaches conversion to K₂CO₃, the rates of capture slow down very quickly. Little to no bicarbonate is formed in this system, meaning that the dominant release step is the conversion of carbonate back to CO₂, which is twice as energy intensive as it would be to convert bicarbonate to CO₂. Due to the slow reaction rates in this system, conversion of carbonate to bicarbonate is not economically feasible, and the resulting solution will also contain some leftover hydroxide ions which are parasitic towards the efficiency of the process.

In the present invention, the capture solution contains an amine which acts as a “promoter” in the carbonate capture solution and increases the formation of bicarbonate anions over carbonate anions in the modified capture solution. The presence of an amine promoter overcomes the problem of slow kinetics of bicarbonate formation which has hampered previous BPMED attempts to capture CO₂. By increasing the selectivity of the capture solution towards bicarbonate anion formation, the energy consumption of the release step is significantly reduced, improving the energy efficiency of the entire operation. The amine promoter creates faster rates of bicarbonate formation which mean a smaller gas-liquid contactor can be used during the contacting step, that less water is lost per cubic metre of gas mixture which contacts the capture solution, and that the process consumes fewer kWh per tonnes of captured CO₂. Amine-containing capture solutions are also less caustic than the KOH used in the prior art, which advantageously decreases handling risks and prolongs the lifespan of apparatus.

The bicarbonate anions are transferred out of the modified capture solution as it passes through the basic compartment of the electrodialysis chamber, and the original capture solution is regenerated. In order to transfer a high proportion of the captured bicarbonate anions out of the modified capture solution, the modified capture solution may optionally be passed through the basic compartment multiple times. The regenerated capture solution can be re-used for contacting more of the gas mixture, for example by recirculating the capture solution back to the gas-liquid contactor.

As the second bipolar membrane provides hydrogen cations to the acidic compartment, the release solution contains both the transferred bicarbonate anions and hydrogen cations, which associate to form carbonic acid. The carbonic acid subsequently decomposes and is released from the second absorbent solution as CO₂ gas.

A significant benefit of this technique is that the release of the captured CO₂ requires very little energy (as low as 750 kWh/tCO₂ or even lower) due to the fact that carbonic acid and its ions are unstable at room temperature. On the other hand, an amine sorbent or carbonate calciner requires between 1500-2000 kWh per tonne of CO₂.

The use of liquid solutions of first and second absorbents advantageously allows easy replenishment of the sorbent in the device when it is spent, making processing significantly simpler than prior art DAC methods relying on solid absorbents.

Particularly preferably the gas mixture is air, and the method is a method of direct air capture (DAC) of CO₂ from air.

This method is advantageously usable to capture CO₂ from dilute gas streams such as air under ambient temperatures and pressures, and to concentrate it to a high purity, while requiring only electrical energy. These benefits make the method of the present invention more environmentally-effective, energy-efficient and lower cost than prior art techniques.

### Capture Solution

The capture solution is preferably an aqueous solution containing an amine and a metal carbonate.

The amine used in the capture solution of the present invention is preferably configured to improve the kinetics of bicarbonate formation in the modified capture solution, while also being compatible with BPMED of the modified capture solution.

By using amines as an accelerant in the capture solution, the present invention is able to achieve higher bicarbonate concentration in the modified capture solution, and higher CO₂ loadings of the capture solvent with less energy.

The amine in the capture solution may be any compound containing an amine-NH-bridge, or an —NH₂ functional group. For example the amine may be an amine compound, an amino acid, piperazine or a derivative thereof, or piperidine or a derivative thereof.

The amine in the capture solution is preferably selected to be an amine for which the CO₂ dissolution equilibrium reactions favour bicarbonate formation. The factors favouring bicarbonate formation depend on the amine—the equilibria governing bicarbonate formation are mainly either the dissociation of the carbamate (for primary and secondary amines) or the direct reactions of the amine with CO₂ and water to form bicarbonate and protonated amine. Example reactions are shown below for a primary amine R and a tertiary amine R′.

Primary amine R reacting to form carbamate:

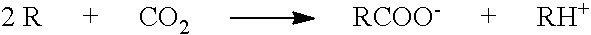

This is followed by carbamate hydrolysis to regenerate the amine and form bicarbonate:

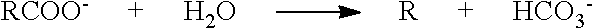

The more unstable the carbamate, the more bicarbonate is formed. Sterically hindered carbamates are more unstable, so in the present invention large primary or secondary amines may be selected to encourage the formation of unstable, sterically hindered carbamate.

Tertiary amine R′ catalysed hydration to form bicarbonate:

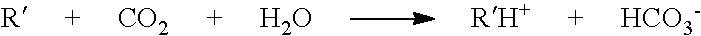

There are several factors that affect the performance of amines including their formation of bicarbonate. Given that the reaction with primary and secondary amines requires two amines to capture one molecule of CO₂, the maximum theoretical loading is 0.5 mol CO₂/mol amine. However, the formation of bicarbonate can arguably in many cases equate to a larger CO₂ loading capacity due to the regeneration of the amine during the process—this allows the regenerated amine to capture more CO₂ and hence increases the maximum theoretical CO₂ loading of primary and secondary amines to 1 mol CO₂/mol amine. This is the same CO₂ loading level that can be achieved with tertiary amines.

The CO₂ absorption performance of a particular amine is significantly affected by kinetics and mass transfer and their inter-play. This has a direct correlation with the structure of the amines. Primary and secondary amines are associated with fast kinetics but lower CO₂ loading capacity, whereas tertiary amines are associated with slow kinetics but higher CO₂ loading capacity. To combat this, the capture solution of the present invention preferably uses amines with specific structural and chemical properties.

Several parameters can be crucial to estimating and correlating the carbon capture efficiency of different amines. These parameters include the carbamate stability constant, K_{carb} and the amine protonation constant, pKa.

The definition of pKa is:

$$pKa = - log Ka$$

where Ka is:

$$Ka = [ Am ] [ H + ] / [ AmH + ]$$

In this equation Am is amine, and [Am] is amine concentration.

Highly stable carbamate formation in the CO₂ absorption process would require a higher regeneration energy to separate anions from the amine and generate a lean solvent. Carbamate formation is associated with high heat of reaction which is related to a high equilibrium temperature sensitivity. In prior art processes, this is typically required for the temperature-swing process for regeneration of the amine; however, it is associated with higher regeneration costs and limits the CO₂ loading capacity. The formation of bicarbonate/carbonate formation is less exothermic and hence requires less regeneration energy. However, amines that favour bicarbonate/carbonate production like tertiary and sterically hindered amines are less energy efficient in the capture step than carbamate-favouring amines such as primary and secondary amines, due to their slower rates of reactions with CO₂.

The amine protonation constant pKa value has been strongly correlated by literature with the rate of CO₂ absorption into aqueous amine solvents, where the reaction rate increases with pKa. The structure of the amine affects its pKa value which ultimately affects the formation of carbamate. Research including both modelling results and experimental work show that the CO₂ absorption capacity of aqueous amine solutions is a function of the CO₂ reactions in the aqueous amine solvents and the basicity of the aqueous amine solvents, which can be expressed using its pKa. The basic strength or pKa of the amine will affect how far both reaction pathways will favour product formation.

The absorption capacity of primary and secondary amines do not necessarily show a strong correlation with pKa. This is expected due to their dependence on the carbamate stability constant and not only pH (and hence pKa).

For tertiary amines, the CO₂ hydration reaction is strongly pH dependent, and the catalysed hydration reaction kinetics of tertiary amines correlate strongly with pKa. Overall, an increase in amine pKa leads to an increase in CO₂ absorption capacity.

The amines usable in the capture solution have been selected by the inventors to provide a balance between fast kinetics in the conversion of CO₂ to bicarbonate anion, and a larger CO₂ loading capacity. The CO₂ loading capacity of a given amine is directly related to the bicarbonate formation in a capture solution containing that amine, as the higher the conversion of CO₂ into bicarbonate the closer the amine can get to achieving the theoretical CO₂ loading of 1 mol CO₂/mol amine, either through the regeneration of the amine or through base catalysis.

In summary, for primary amines it is preferred in the present invention to use amines which have a high pKa and a low carbamate stability, and which therefore generate a higher concentration of bicarbonate in the capture solution. For tertiary amines, carbamate formation is not possible and so amines which have high pKa are also desired. Where tertiary amines already produce bicarbonate, but we are looking to achieve the maximum concentration of bicarbonate and hence a higher CO₂ loading capacity. The table below shows the pKa and carbamate stability constants for a variety of amines studied.

The amine preferably has a carbamate stability constant, log K_{carb}, of less than 1.9, preferably less than 1.6, at 298.15 K. The inventors have found that amines having carbamate stability constants in this range advantageously favour bicarbonate formation, which improves the energy efficiency of the CO₂ capture and release process.

The amine preferably has an amine protonation constant, pKa, of greater than 9.6, preferably greater than 9.8 or greater than 10.0 at 298.15 K. The inventors have found that amines having an amine pKa in this range demonstrate an advantageously high CO₂ absorption reaction rate which improves the efficiency of the CO₂ absorption process.

Preferably, the amine may have a carbamate stability constant, log K_{carb}, of less than 1.9 and a pKa of greater than 9.6 at 298.15 K. Particularly preferably the amine may have a carbamate stability constant, log K_{carb}, of less than 1.6 and a pKa of greater than 9.8 at 298.15 K. The inventors have found that amines having this particular combination of carbamate stability constant and amine protonation constant are particularly effective in the present invention, as they provide a particularly effective combination of CO₂ loading capacity, and kinetically-favourable conversion rates of dissolved CO₂ into bicarbonate anions.

The amines selected for use in the present invention are those which the inventors have found to have favourable structures to achieve enhanced bicarbonate production, where the amine structures directly affect their carbamate stability or reaction mechanism.

The amine may be a primary amine. For example the amine may be monoethanolamine (MEA) or 2-amino-2-methyl-1-propanol (AMP). AMP is a primary amine, but the secondary methyl group shields the amino group to a significant extent, and carbamate formation is made more difficult. Thus, because the reaction product is carbonate rather than carbamate, the inventors theorise that regeneration energy for AMP is lower than for MEA. The inventors consider that steric hindering or shielding also means that each CO₂ molecule uses only one AMP molecule, potentially doubling the capacity of an AMP-containing capture solution.

Alternatively the amine may be a secondary amine.

The amine may be a tertiary amine. For example the amine may be N-methyldiethanolamine (MDEA). In the prior art, tertiary functional group amines have been thought not to have a significant promoting effect (Thee et al., 2012a,b; Versteeg et al., 1996). Surprisingly, however, the present inventors have found tertiary amines such as MDEA to provide a beneficial promoting effect in the present invention.

The amine in the capture solution may be selected from the list: Monoethanolamine (MEA); N-methyldiethanolamine (MDEA); 2-amino-2-methyl-1-propanol (AMP); 2-amino-1-propanol (AP); 3-amino-1-propanol (MPA); Diethanolamine (DEA); Piperazine (PZ); 2-(isopropylamino) ethanol (IPAE); Ethylenediamine (EDA); Propylamine; 3-piperidinemethanol (3PM); 2-methyl propanamine; 2-amino-2-methyl-1,3-propanediol (AMPD); 2-amino-2-methyl-1,3-propanediol (AEPD); 2-(methylamino) ethanol (MMEA); Piperidine; Triethanolamine (TEA); 4-amino-1-butanol (4A1B); 5-amino-1-pentanol (5A1PM); Isobutylamine (IBA); 1-(2-aminoethyl) piperazine (AEP).

The amine in the capture solution may be selected from the list: N-methyldiethanolamine (MDEA); 2-amino-2-methyl-1-propanol (AMP); 2-amino-1-propanol (AP); 3-amino-1-propanol (MPA); Diethanolamine (DEA); Piperazine (PZ); 2-(isopropylamino) ethanol (IPAE); Ethylenediamine (EDA); Propylamine; 3-piperidinemethanol (3PM); 2-methyl propanamine; 2-amino-2-methyl-1,3-propanediol (AMPD); 2-amino-2-methyl-1,3-propanediol (AEPD); 2-(methylamino) ethanol (MMEA); Piperidine; Triethanolamine (TEA); 4-amino-1-butanol (4A1B); 5-amino-1-pentanol (5A1PM); Isobutylamine (IBA); 1-(2-aminoethyl) piperazine (AEP).

The amine in the capture solution may be selected from the list: 2-amino-2-methyl-1-propanol (AMP); 2-amino-1-propanol (AP); 3-amino-1-propanol (MPA); Diethanolamine (DEA); Piperazine (PZ); 2-(isopropylamino) ethanol (IPAE); Ethylenediamine (EDA); Propylamine; 3-piperidinemethanol (3PM); 2-methyl propanamine; 2-amino-2-methyl-1,3-propanediol (AMPD); 2-amino-2-methyl-1,3-propanediol (AEPD); 2-(methylamino) ethanol (MMEA); Piperidine; Triethanolamine (TEA); 4-amino-1-butanol (4A1B); 5-amino-1-pentanol (5A1PM); Isobutylamine (IBA); 1-(2-aminoethyl) piperazine (AEP).

The properties of a variety of amines are set out in Table 1 below.

TABLE 1

| | | Carbamate | |
|---|---|---|---|
| | | stability | Reference (source of |
| | | constant at | pKa & Carbamate |
| Amine | pKa | 298.15 K | stability constant) |
| Monoethanolamine (MEA) | 9.65 | log Kc ~1.80 | Wada et al., (2021); |
| | | | Ciftja et al., (2014) |
| N-methyldiethanolamine (MDEA) | 8.52 | N/A | Taguiri et al., (2015) |
| 2-amino-2-methyl-1-propanol | 9.73 | ~0.98 | Wada et al., (2021) |
| (AMP) | | | |
| 2-amino-1-propanol (AP) | 9.65 | ~0.98 | |
| 3-amino-1-propanol (MPA) | 9.90 | ~1.54 | Perinu et al., (2014) & |
| | | | Benamor et al., (2015) |
| Diethanolamine (DEA) | 8.90 | ~0.92 | Wada et al., (2021) |
| Piperazine (PZ) | 9.83 | ~1.50 | Taguiri et al., (2015) & |
| 2-(isopropylamino)ethanol (IPAE) | 10.1 | ~0.84 | |
| Ethylenediamine (EDA) | 9.92 | ~2.60 | Da silva (2009) |
| Propylamine | 10.6 | ~1.67 | Mcann et al., (2011) |
| 3-piperidinemethanol (3PM) | 10.28 | ~1.50 | Conway et al., (2011) |
| 2-methyl propanamine | 10.5 | | Da silva (2009) |
| 2-amino-2-methyl-1,3-propanediol | 8.8 | | Hamborg & Versteeg |
| (AMPD) | | | (2009) |
| 2-amino-2-methyl-1,3-propanediol | 8.8 | | Hamborg & Versteeg |
| (AEPD) | | | (2009) |
| 2-(methylamino)ethanol (MMEA) | 9.85 | | Hamborg & Versteeg |
| | | | (2009) |
| Piperidine | 11.12 | | Da silva (2009) |
| Triethanolamine (TEA) | 7.76 | | Vaidya & Kenig (2007) |
| 4-amino-1-butanol (4A1B) | | ~1.79 | Perinu et al., (2014) |
| 5-amino-1-pentanol (5A1PM) | | ~1.79 | Perinu et al., (2014) |
| Isobutylamine (IBA) | | ~1.69 | |

In some embodiments, the amine in the capture solution may be a polymeric amine, preferably a cationic polymer amine, for example a cationic polymer having a repeat unit which comprises a plurality of amine groups.

In a preferred embodiment, the capture solution comprises polyethyleneimine (PEI), which is a polymeric amine. PEI is available with different molecular weights. PEI with a molecular weight of 800 g/mol has a pKa of 9.94, while PEI with a molecular weight of 2000 g/mol has a pKa of 9.38.

Physical properties of mixed absorbent capture solutions including density, viscosity and surface tension also affect the transfer performance and hence absorption capacity. The absorption capacity of the capture solution depends on not only the absorption rate, but also the solubility of CO₂. The solubility of CO₂ is closely related to capture solution viscosity because viscosity affects the liquid film coefficient for mass transfer. High capture solution viscosity decreases the diffusion coefficient of CO₂ in the capture solution and hinders the absorption process. Several factors including the concentration, temperature and pressure gradients affect diffusion. Density, viscosity, and diffusion coefficients are used to determine the mass transport properties of molecules in a system, which has a direct effect on the kinetics of the process due to their inter-play in the gas-liquid absorption.

The capture solution may contain 5-20 wt % amine, or 7-15 wt % amine, or 8-13 wt % amine. The inventors have found that amine contents in this range result in the best balance of density and viscosity of the capture solution, and the most effective CO₂ capture.

The metal carbonate in the capture solution may be an alkali metal carbonate. In preferred embodiments, the capture solution contains potassium carbonate.

The inventors have found that controlling the pH of the capture solution throughout its cycle of CO₂ absorption and bicarbonate separation in the BPMED system is vital to energy efficient operation of the process.

As CO₂ is captured, the pH of the capture solution decreases as carbamate, carbonate and bicarbonate is formed. The lower the pH of the modified capture solution, the higher the concentration of bicarbonate in the modified capture solution. Once a target pH threshold is met, the capture solvent is processed using a BPMED cell in which anions from the capture solution are transferred to the release solution. For every anion that is transferred into the release solution, the equivalent amount of protons to achieve charge neutrality are generated by the BPMED cell, for example 2 H⁺ for CO₃²⁻ and 1 H⁺ to HCO₃. On protonation and sufficient concentration of H₂CO₃, CO₂ will degas from the release solution. Separating the bicarbonate and carbonate anions out of the modified capture solution regenerates a stream of the capture solution which is reduced in dissolved CO₂ species and can either be sent directly back to the gas-liquid contactor to absorb more CO₂ or it can be recirculated around the BPMED stack.

The highest CO₂ capture rates occur at high pH values, so previous attempts at CO₂ capture have typically operated with highly alkaline capture solutions at pH 12 and above, which can be achieved with alkaline capture solvents such as KOH. The highest CO₂ evolution rates during electrodialysis occur at lower pH values i.e. when there is a high bicarbonate concentration in the modified capture solution. This desire to have highly alkaline capture solution, but much less alkaline modified capture solution at the point of entering the BPMED system, can lead to large pH gradients across the flow path of the electrodialysis cell, which can damage the ion-exchange membranes. In particular, anion-exchange membranes and bipolar membranes degrade faster at higher pH (pH 12 and above).

The method of the present invention is preferably a continuous process, in which regenerated capture solution is recirculated to a gas-liquid contactor to repeat the process. As the modified capture solution does not discharge 100% of carbonate and bicarbonate anions during the electrodialysis step, the composition and thus the pH of the regenerated capture solution will differ from that of new, unused, capture solution.

In the present invention, the pH of brand new capture solution, which has not been brought into contact with the gas mixture, is preferably between pH 12 and pH 12.75, particularly preferably around pH 12.5.

Once the continuous process is operating, the pH of the regenerated capture solution will gradually decrease as the carbonate and bicarbonate concentration in the regenerated capture solution increases, until the process reaches a steady state.

At steady-state operation, the composition and pH of the regenerated capture solution (after electrodialysis, and before contacting the gas mixture) reaches a steady state, and the composition and pH of the modified capture solution partially loaded with dissolved CO₂, after the gas contacting step and before the electrodialysis step) reaches a steady state. Steady state is achieved by matching the capture flux with the release flux. This can be achieved either by changing the air velocity, or more conveniently by adjusting the current density The pH of the capture solution then varies between these two steady state values during each process cycle.

In steady-state operation of the continuous process, the capture solution preferably cycles within a pH range of pH 10.5-11, or pH 10.8-11, as bicarbonate is generated to form the modified capture solution and discharged to form the regenerated capture solution.

In the present invention, the regenerated capture solution is preferably buffered to a pH of less than 12, or less than 11.5, or less than 11, before being contacted by the gas mixture, and the modified capture solution is preferably subjected to electrodialysis when the modified capture solution has a pH of 9.5 or greater, or 10 or greater, or 10.5 or greater. This protocol advantageously prolongs the lifetime of the ion-exchange membranes in the BPMED system.

After the step of contacting the gas mixture with the capture solution, and before the step of performing electrodialysis on the modified capture solution, the modified capture solution preferably has a pH of between 9.5 and 11, preferably between 10 and 11 or between 10.5 and 11. The step of contacting the gas mixture with a capture solution and dissolving CO₂ in the capture solution may be carried out until the modified capture solution reaches a threshold pH. When the threshold pH is reached, the modified capture solution may be transported to the BPMED cell for electrodialysis. The threshold pH may be 10.8 or less, or 10.5 or less, or 10.3 or less.

In a preferred embodiment, the capture solution is maintained between pH 11.5 and pH 9.5 as CO₂ is dissolved and released during electrodialysis. In particularly preferred embodiments the capture solution is maintained between pH 11 and pH 10 throughout the cycle of CO₂ being dissolved and released during electrodialysis.

The inventors have found that the use of amines in a carbonate capture solution within this pH range allows for fast absorption kinetics during the capture step, and fast desorption kinetics during electrodialysis. A particular difference from alternative processes is that this pH window would not be viable for processes requiring thermal regeneration of capture agents (for example amines), because the CO₂ loading at these pH levels would be too low to be remotely energy efficient. Furthermore, the inventors have found that the BPMED can achieve high current efficiencies and energy efficiencies in this range.

### Bipolar Membrane Electrodialysis System

The bipolar membrane electrodialysis system preferably comprises a BPMED cell containing at least one anion-exchange membrane. The BPMED cell is preferably configured to transfer bicarbonate ions from a stream of modified capture solution, through the anion exchange membrane, into a stream of the release solution.

The BPMED cell preferably comprises a plurality of BPM-AEM pairs.

In a preferred embodiment, the anion-exchange membrane of the BPMED cell may be a monovalent selective anion-exchange membrane which is configured to allow passage of monovalent bicarbonate anions from the modified capture solution into the release solution. The use of a monovalent anion-exchange membrane may further improve the selectivity of bicarbonate anion transfer, and prevent the transfer of divalent carbonate anions which require twice as much energy to convert into CO₂ gas in the release solution.

The selective passage of bicarbonate anions into the release solution may be further improved by positioning an ion-exchange resin in one or more compartment(s) of the BPMED cell. The use of ion-exchange resins between ion-exchange membranes is known in the field of water electrodeionisation, which is a technology used to produce pure water. The present inventors have realised, however, that by incorporating into the BPMED cell an ion-exchange resin which selectively binds particular ions, for example bicarbonate anions, the selective transfer of bicarbonate to the release solution can be greatly enhanced.

The selective passage of bicarbonate anions into the release solution may be further improved by positioning an anion-exchange resin in the basic compartment(s) of the BPMED cell (the compartment containing the modified capture solution). The use of ion-exchange resins between ion-exchange membranes is known in the field of water electrodeionisation. The present inventors have realised, however, that by incorporating an anion-exchange resin which selectively binds monovalent bicarbonate anions to a greater extent than it binds divalent carbonate anions, the selective transfer of bicarbonate to the release solution can be greatly enhanced. The use of ion-exchange resin increases the concentration of bicarbonate at the membrane interface, encouraging bicarbonate transfer into the release solution. The anion-exchange resin may be monovalent-selective so that the resin binds monovalent bicarbonate anions more than divalent carbonate anions.

As the modified capture solution-which contains bicarbonate anions but also some carbonate anions-flows through the ion-exchange-resin-filled compartment of the BPMED cell, bicarbonate anions are selectively bound to the resin, and gradually migrate to the anion-exchange membrane under the influence of the applied electric field. The carbonate anions in the modified capture solution bind less to the ion-exchange resin, which has a much higher selectivity for bicarbonate, so a higher proportion of carbonate anions remain in the regenerated capture solution, and may eventually be converted to bicarbonate.

As bicarbonate conversion to gaseous CO₂ consumes only half of the energy needed for the equivalent carbonate reaction, the improved transfer selectivity provided by the ion-exchange resin in the BPMED cell significantly reduces the energy consumption of the entire carbon dioxide capture process.

A variety of commercially available ion-exchange resins are usable in the BPMED cell. For example macroporous polymer matrix resins such as Amberlite® IRA 743 and IRA 900 may be used. Microporous gel resins such as Amberlite® IRN 78 and IRM 410 may also be used.

### Release Solution

A variety of release solutions may be used in the present invention. Preferably the release solution is an aqueous solution containing an alkali-metal salt.

The release solution may comprise an alkali metal sulphate, for example K₂SO₄. Alternatively the release solution may comprise a mixture of alkali metal carbonate and bicarbonate, for example a mixture of KHCO₃/K₂CO₃.

In a particularly preferred embodiment, the release solution comprises phosphate anions. During testing of multiple release solutions, the inventors have found that phosphate counterions resulted in the highest CO₂ output owing to its comparatively low pH, as the equilibrium of CO₂ in water will shift towards CO₂ generation in more acidic media. The weak acidity of phosphate electrolytes meant that phosphate solutions were found to be the most effective of multiple salts for CO₂ regeneration from the release solution.

The release solution preferably comprises an alkali metal phosphate, such as NaH₂PO₄ or K₃PO₄.

Following the step of transferring bicarbonate ions into the release solution, the release solution preferably has a pH of pH 6 or less, or pH 5 or less, or pH 4 or less.

Particularly preferably, the release stream is maintained at a pH of between 3 and 5, for example between pH 3.5 and 4.5 to ensure that all carbonaceous species are converted to CO₂ and to prevent back diffusion of HCO₃.

The release of CO₂ gas from the release solution preferably takes place at atmospheric pressure and ambient temperature, without any requirement for heating or external energy input to the release solution. The release of the CO₂ gas from the release solution preferably regenerates the original release solution.

The method is preferably a continuous process, in which a stream of capture solution is continuously circulated between a gas-liquid contactor and the BPMED cell, while a stream of the release solution is continuously circulated between the BPMED cell and the release vessel.

### Apparatus

In a third aspect, the invention provides an apparatus for capturing CO₂ from a gas mixture, comprising:

a gas-liquid contactor configured to contact a gas mixture containing CO₂ with a capture solution, dissolving CO₂ in the capture solution to form a modified capture solution containing bicarbonate anions;

a bipolar membrane electrodialysis (BPMED) cell comprising one or more ion-exchange membranes for electrochemically separating bicarbonate anions from the modified capture solution and transferring bicarbonate anions to a release solution; and a release vessel for releasing at least some of the CO₂ from the release solution.

The gas-liquid contactor may comprise a packed column, a gas sparger or a falling film reactor. In a preferred embodiment, the gas-liquid contactor comprises a high surface area packing material supported by a large gas-contacting structure which is configured to bring the gas into contact with the capture solution.

The gas-liquid contactor may be configured to carry out the gas-liquid contacting in cross-flow, with gas and liquid flows moving an orthogonal directions, and/or co-flow, in which gas and liquid flows move in the same direction. The gas-liquid contactor may be configured to carry out the gas-liquid contacting in counter-flow, in which gas and liquid flows move in opposite directions.

The BPMED cell comprises at least one pair of electrodes (an anode and a cathode), and is configured to apply an electrical potential difference between the electrodes to separate the bicarbonate anions from the capture solution and transfer them to the release solution.

The BPMED cell may be configured to operate under an elevated pressure, in order to suppress the formation of target species gas bubbles in the BPMED cell. Preferably the BPMED cell may be configured to operate under a hydrostatic pressure of greater than 2 atm, preferably greater than 3 atm or 5 atm or 7 atm, or even 30 atm or higher.

The one or more ion-exchange membrane preferably comprises, or consists of, an anion-exchange membrane configured to permit passage of bicarbonate anions therethrough.

The bipolar membrane electrodialysis (BMPED) cell comprises an electrodialysis cell containing at least one bipolar membrane (BPM) which is configured to split water into H⁺ and OH ions, and at least one ion-exchange membrane which is configured to separate the release solution from the capture solution.

A variety of BPMED cell configurations can be used with the present invention, and the size of the cell, the separation between membranes, and the number of membrane pairs can be varied according to the requirements of individual systems.

In a preferred embodiment, the BPMED electrodialysis cell has a BPM-AEM-BPM configuration and comprises a basic compartment positioned between a first bipolar membrane and an anion-exchange membrane, and an acidic compartment positioned between the other side of the anion-exchange membrane and a second bipolar membrane. Electrodes are positioned outside the two outermost bipolar membranes and configured to apply an electrical potential across the electrodialysis chamber. The bipolar membrane electrodialysis system is preferably configured so that capture solution containing bicarbonate anions is circulated between the basic compartment and the gas contactor, while the release solution is circulated between the acidic compartment and a release vessel.

The apparatus is preferably configured to continuously circulate capture solution between the gas-liquid contactor and the BPMED cell. The apparatus is preferably configured to continuously circulate release solution between the BPMED cell and the release vessel.

The BPMED cell preferably comprises a plurality of BPM-AEM pairs.

In a preferred embodiment, the anion-exchange membrane of the BPMED cell may be a monovalent selective anion-exchange membrane which is configured to allow passage of monovalent bicarbonate anions from the modified capture solution into the release solution. The use of a monovalent anion-exchange membrane may further improve the selectivity of bicarbonate anion transfer, and prevent the transfer of divalent carbonate anions which require twice as much energy to convert into CO₂ gas in the release solution.

The BPMED cell may comprise an ion-exchange resin in one or more compartment(s) of the BPMED cell. The BPMED cell may comprise an anion-exchange resin in either the basic compartment (capture solution compartment) or the acidic compartment (release solution compartment) of the BPMED cell. The BPMED cell may comprise a cation-exchange resin in either the basic compartment (capture solution compartment) or the acidic compartment (release solution compartment) of the BPMED cell. The use of ion-exchange resins between ion-exchange membranes is known in the field of water electrodeionisation. The present inventors have realised, however, that by incorporating into the BPMED cell an ion-exchange resin which selectively binds particular ions, for example bicarbonate anions, the selective transfer of bicarbonate to the release solution can be greatly enhanced.

The BPMED cell may comprise an ion-exchange resin in the basic compartment(s) of the BPMED cell (the compartment containing the modified capture solution). The present inventors have realised, however, that by incorporating into the capture-solution compartment an anion-exchange resin which selectively binds monovalent bicarbonate anions, but does not bind divalent carbonate anions, the selective transfer of bicarbonate to the release solution can be greatly enhanced. The use of ion-exchange resin increases the concentration of bicarbonate at the membrane interface, encouraging bicarbonate transfer into the release solution.

A variety of commercially available ion-exchange resins are usable in the BPMED cell. For example macroporous polymer matrix resins such as Amberlite® IRA 743 and IRA 900 may be used. Microporous gel resins such as Amberlite® IRN 78 and IRM 410 may also be used.

### DETAILED DESCRIPTION

Specific embodiments of the invention will now be described by way of example, with reference to the accompanying drawings, in which:

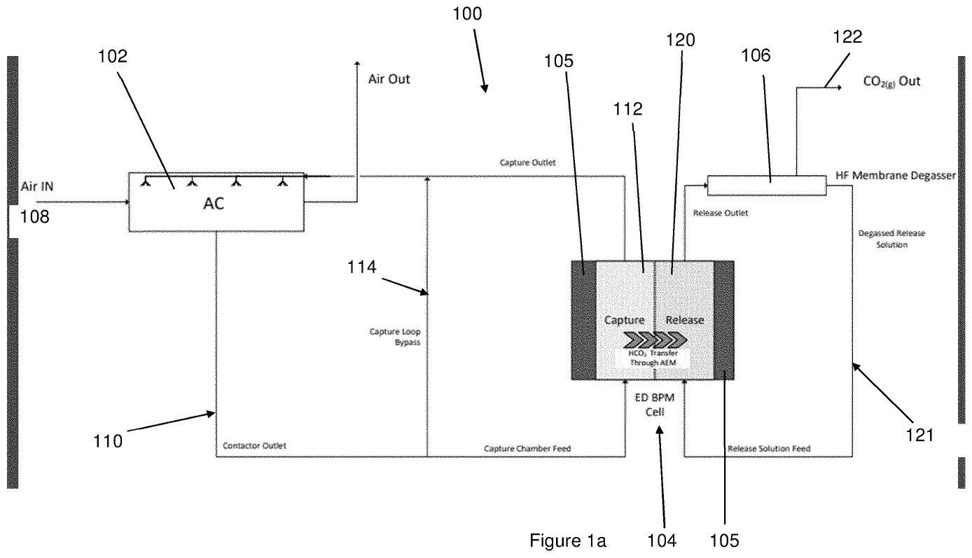

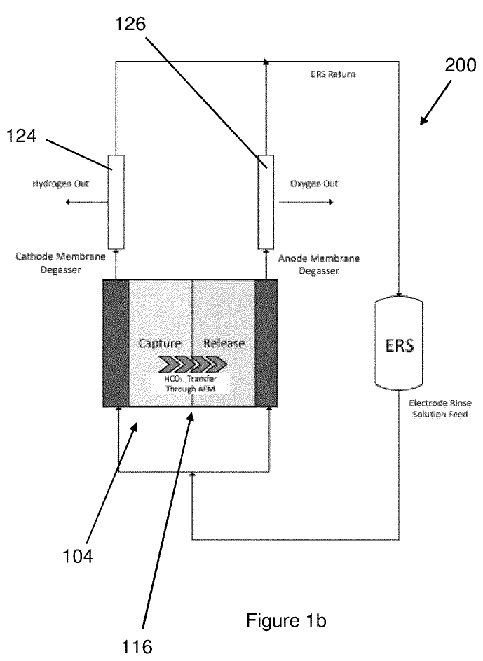

FIG. 1a is a schematic process flow diagram illustrating an exemplary apparatus usable for the method of the present invention;

FIG. 1b is a schematic process flow diagram illustrating the flow of electrode solution to the apparatus of FIG. 1a;

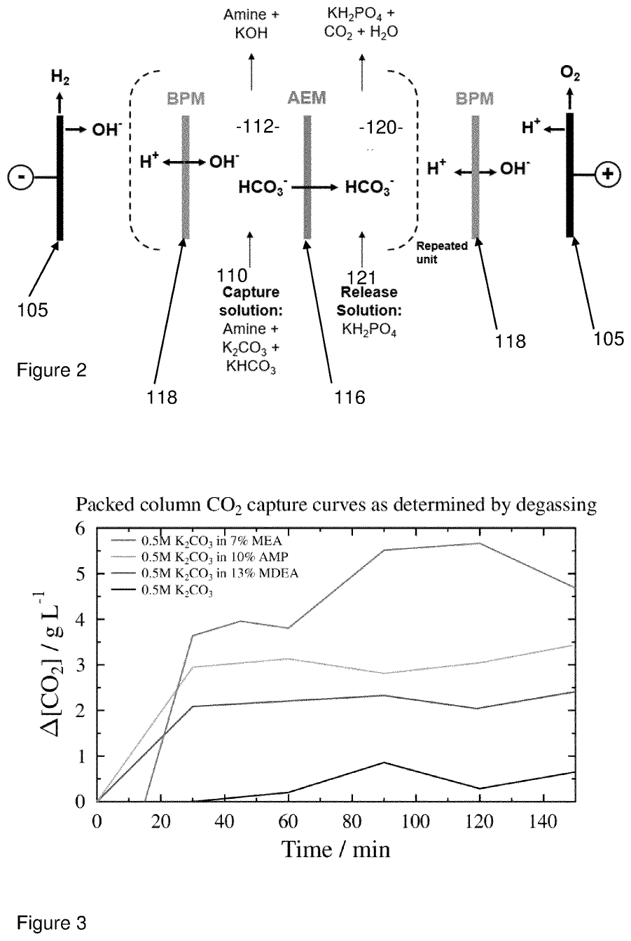

FIG. 2 is a schematic diagram illustrating a bipolar membrane electrodialysis cell usable in the present invention;

FIG. 3 is a diagram comparing the CO₂ captured by different capture solutions usable in the present invention;

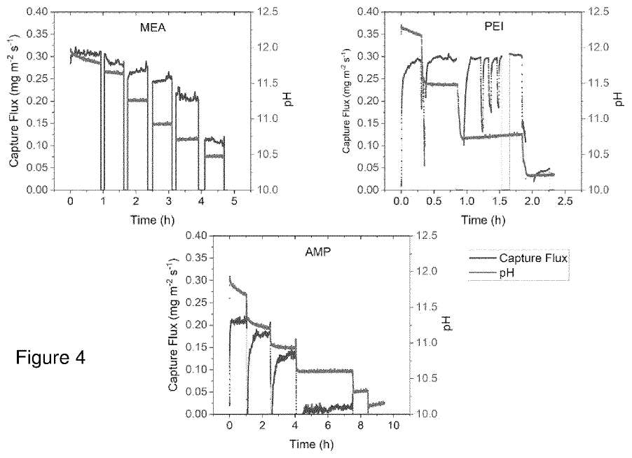

FIG. 4 is a diagram comparing the capture flux and pH of different capture solutions usable in the present invention;

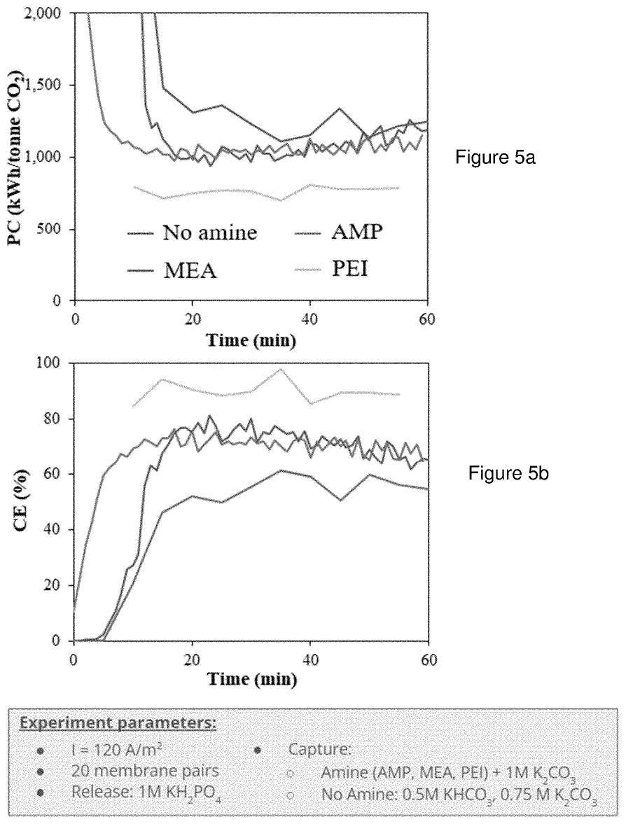

FIG. 5a is a diagram comparing the power consumption (PC) to regenerate different capture solutions usable in the present invention;

FIG. 5b is a diagram comparing the current efficiency (CE) to regenerate different capture solutions usable in the present invention;

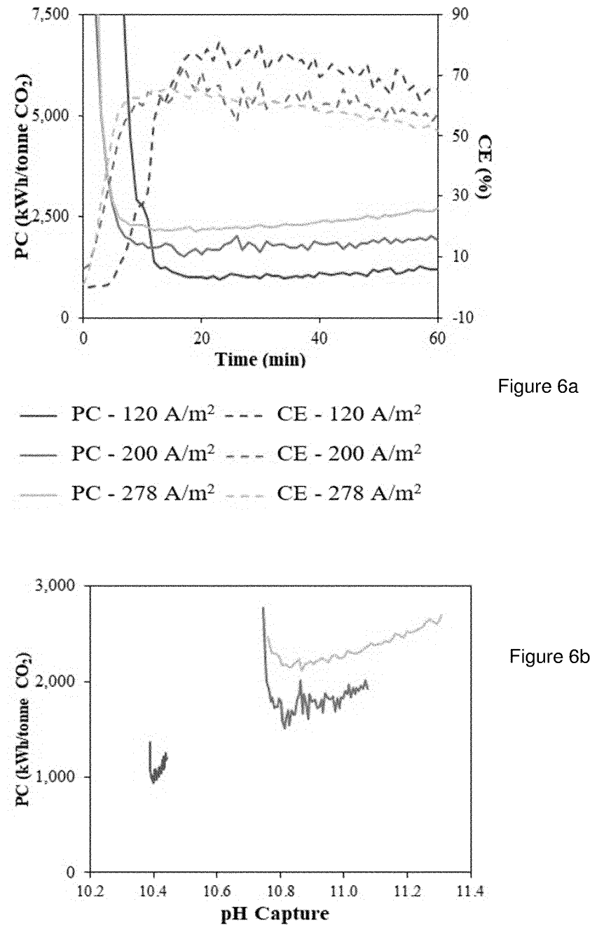

FIG. 6a is a diagram comparing the power consumption and current efficiency of the method of the present invention at different current densities;

FIG. 6b is a diagram comparing the power consumption of the method of the present invention at different capture pH;

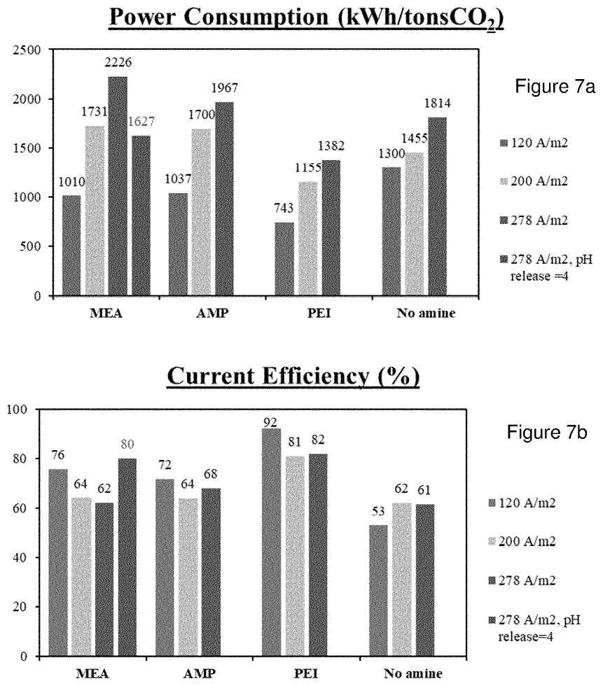

FIG. 7a is a diagram of the power consumption of different capture solutions usable in the present invention at different current densities;

FIG. 7b is a diagram of the current efficiency of different capture solutions usable in the present invention at different current densities;

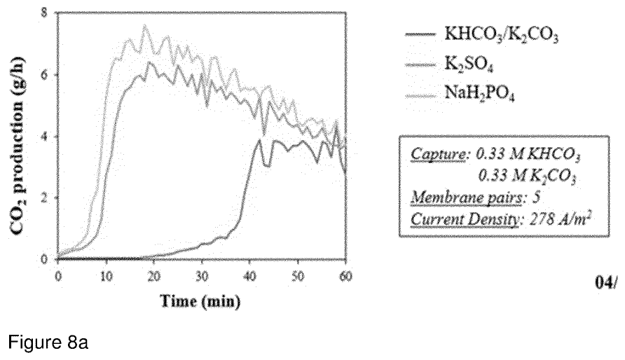

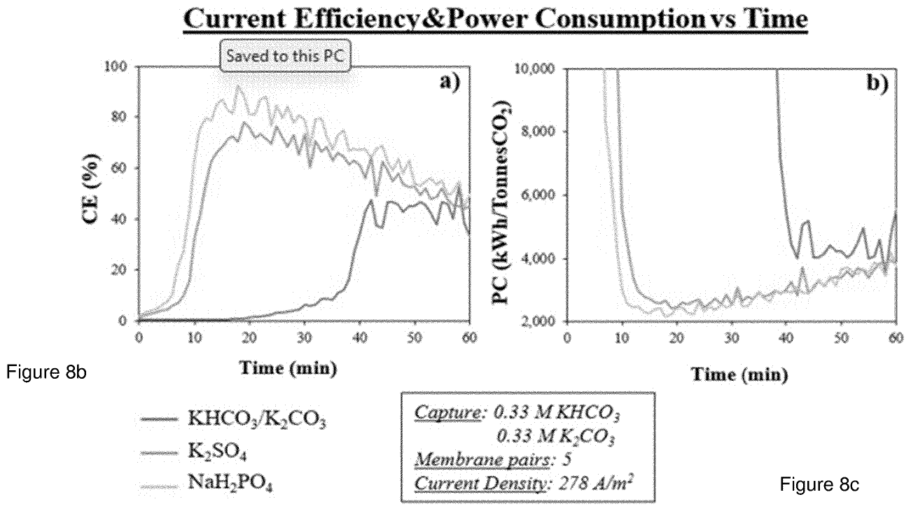

FIG. 8a is a graph of CO₂ released by three different release solutions usable in the present invention;

FIG. 8b is a graph of CE relating to three different release solutions usable in the present invention;

FIG. 8c is a graph of PC relating to three different release solutions usable in the present invention;

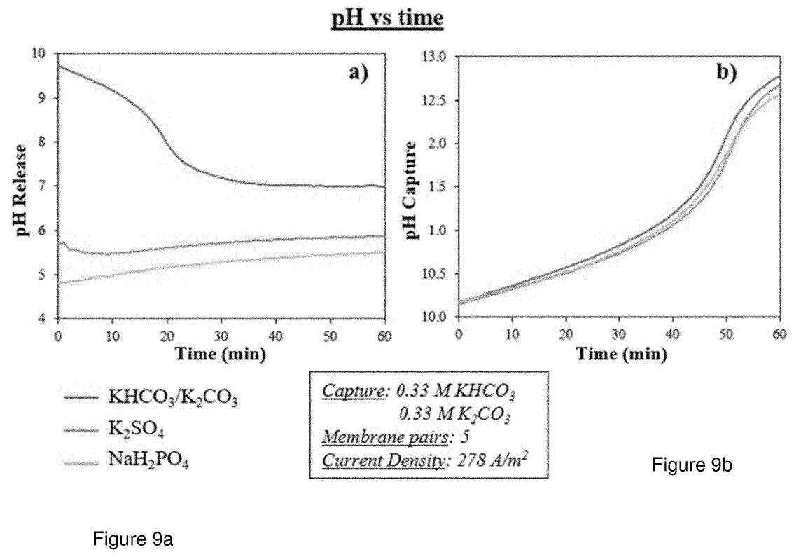

FIG. 9a is a graph of release pH for three different release solutions usable in the present invention;

FIG. 9b is a graph of capture pH for three different release solutions usable in the present invention;

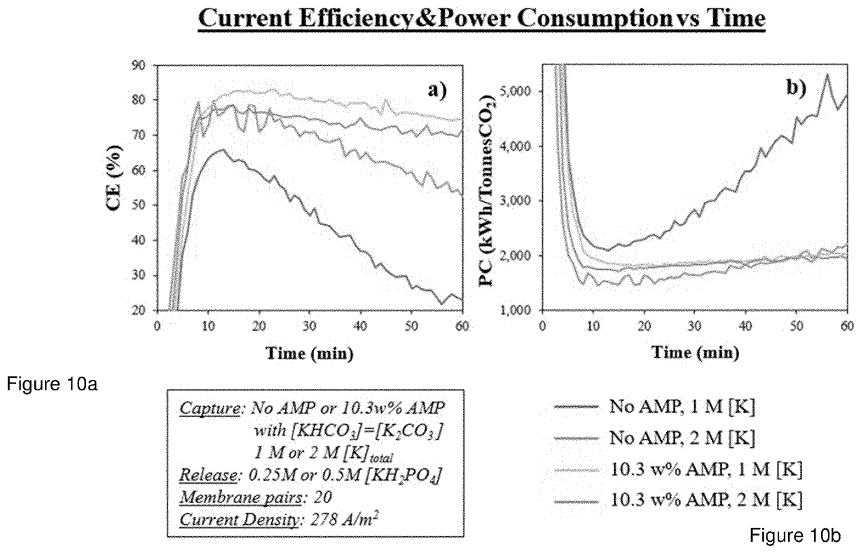

FIG. 10a is a graph comparing the CE of the process using capture solutions according to the invention, with the same process using an amine-free capture solution;

FIG. 10a is a graph comparing the PC of the process using capture solutions according to the invention, with the same process using an amine-free capture solution; and

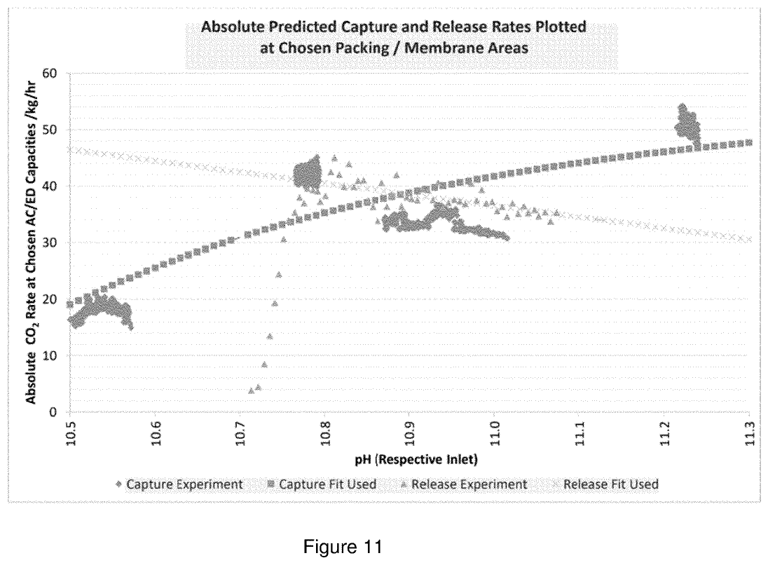

FIG. 11 is a diagram overlaying the capture flux and the release flux of the method of the present invention with a preferred pH window.

An exemplary apparatus usable for the method of the present invention is shown in FIGS. 1a and 1b, while FIG. 2 illustrates a BPMED configuration which can be integrated with the system of FIGS. 1a and 1b.

The Figures will be described with reference to the preferred embodiment of the invention in which the gas mixture is air, such that the invention provides a method of direct air capture (DAC) of CO₂. The skilled person will appreciate, however, that the gas mixture need not necessarily be air, and may alternatively be another gas mixture which contains CO₂.

The flow-BPMED apparatus 100 illustrated in FIGS. 1a and 1b is made up of a gas-liquid contactor 102, a BPMED cell 104, and a membrane degasser 106.

The gas-liquid contactor 102 is arranged to receive a flow of gas 108 (preferably air) which contains gaseous CO₂ to be captured, and to bring the gas into contact with a stream of a capture solution 110. A variety of gas-liquid contactor designs are known in the art, such as falling-film columns, packed columns, bubble columns or spray towers, any of which would be suitable for use with the present invention.

Capture solution pipework connects an outlet of the gas-liquid contactor 102 with the inlet of a first compartment 112 of the BPMED cell 104, and return pipework connects an outlet of the first compartment 112 with the gas-liquid contactor. Capture solution can thus be continuously circulated between the gas-liquid contactor and the first compartment 112 of the BPMED cell 104. The pipework includes a capture loop bypass 114 which bypasses the BPMED cell 104, so that, if desired, capture solution can be recirculated through the gas-liquid contactor multiple times before it is routed to the BPMED cell. The flow of liquid through the pipework is controlled by a series of valves and one or more pumps which are not shown in the simplified schematics of FIGS. 1a and 1b.

The BPMED cell 104 contains a pair of electrodes 105 arranged either side of a stack of ion-exchange membranes. The BPMED cell may contain a plurality of membrane pairs, with each repeat unit consisting of a bipolar membrane (BPM) and an anion-exchange membrane (AEM) as shown in FIG. 2. In the simplified cell shown in the Figures, however, the BPMED cell 104 has a BPM-AEM-BPM configuration, in which a single anion-exchange membrane 116 is positioned between two bipolar membranes 118. The anion-exchange membrane 116 divides the interior of the cell into two compartments: a first compartment 112, through which a stream of capture solution is fed; and a second compartment 120, through which a stream of release solution 121 is fed.

Release solution pipework connects an outlet of the second compartment 120 of the BPMED cell 104 with the membrane degasser 106, and further pipework connects a liquid outlet of the membrane degasser with an inlet of the second compartment 120. Release solution can thus be continuously circulated between the second compartment 120 of the BPMED cell 104 and the membrane degasser 106.

The membrane degasser 106 has a gas outlet 122 through which evolved CO₂ gas is released. The gas outlet 122 may be connected to a storage vessel (not shown).

As shown in FIG. 1b, the electrodes 105 of the BPMED cell 104 are configured to receive a continuous feed of electrode rinse solution, which is circulated through an electrode circuit 200. The electrode circuit 200 also contains a cathode membrane degasser 124 in line with the cathode of the BPMED cell, and an anode membrane degasser 126 in line with the cathode of the BPMED cell. The cathode membrane degasser strips the used electrode rinse solution of gaseous hydrogen which is evolved at the cathode during electrodialysis, while the anode membrane degasser strips the used electrode rinse solution of gaseous oxygen which is evolved at the anode.

In use, a gas mixture is fed to the gas-liquid contactor 102, where the gas mixture contacts a stream of capture solution 110 which contains an amine and a metal carbonate, and gaseous CO₂ is dissolved into the capture solution. As the capture solution dissolves CO₂, the amine in the capture solution encourages the formation of bicarbonate anions HCO₃⁻, and the capture solution becomes a modified capture solution which contains bicarbonate anions as well as carbonate anions CO₃²⁻. The formation of bicarbonate anions in the capture solution generates hydrogen cations and lowers the pH of the capture solution, so that the modified capture solution has a lower pH than the pH of the capture solution before the CO₂ absorption.

The modified capture solution 110 is fed to the first compartment 112 of the BPMED cell 104, where the electrical potential applied across the BPMED cell between the electrodes 105 desorbs the bicarbonate anions from any associated metal cations, and transports the bicarbonate anions any carbonate anions through the anion-exchange membrane 116 into the second compartment 120 of the BPMED cell 104.

At both BPMs, H₂O is dissociated into H⁺ and OH⁻.

Hydroxide anions OH are fed into the first compartment 112 from the adjacent BPM. The loss of the bicarbonate anions and the addition of hydroxide anions increases the pH of the modified capture solution back towards its starting pH and its original composition, so that the capture solution is regenerated as it passes through the BPMED cell. The regenerated capture solution is then pumped back to the gas-liquid contactor for re-use.

Hydrogen cations H⁺ are fed into the second compartment 120 from its adjacent BPM 118, such that the stream of release solution 121 receives bicarbonate anions from the AEM 116 and hydrogen cations from the BPM 118. The hydrogen and bicarbonate ions associate to form carbonic acid in the release solution, which decomposes to CO₂ gas and H₂O without any additional energy input. The evolved CO₂ gas is removed from the release stream by the membrane degasser 106, and preferably stored, before the degassed release solution is circulated back to the second compartment 120 of the BPMED cell 104 for re-use.

As hydrogen cations are generated by the BPM 118 adjacent the cathode, the hydrogen cations migrate to the cathode and form H₂ gas. Meanwhile, hydroxide anions are generated by the BPM adjacent to the anode, which migrate to the anode and form O₂ gas.

In the embodiment illustrated in FIG. 2, the modified capture solution contains amine, potassium carbonate and potassium bicarbonate as it enters the BPMED cell. As discussed above in the summary of the invention, a variety of primary, secondary and tertiary amines may be used to encourage bicarbonate formation over carbonate formation in the modified capture solution. The pH of the capture solution/modified capture solution is preferably maintained between at higher pH, for example around pH 11 (after exit from the BPMED system/before entering the contactor) and at a lower pH, for example pH 10.8 10.5—pH 10 (when the modified capture solution is partially loaded with CO₂ prior to entering the BPMED cell). Maintaining the capture solution circuit in this pH range has been found to provide an optimal balance of absorption and desorption kinetics and CO₂ loading capacity.

As discussed above in the summary of the invention, the release solution preferably contains an alkali metal salt. In the preferred embodiment illustrated in FIG. 2, the release solution is an aqueous solution of KH₂PO₄, which has been found to be highly effective. The release solution is preferably maintained at a pH of around pH 4, which the inventors have found optimal for CO₂ release.

FIG. 3 shows a comparison of different amine-promoted carbonate solutions showing their promotion effect in terms of the change in CO₂ concentration across time in a packed absorption column. The air velocity used was 1.47 m/s with a flow rate of 15 L/min, the liquid flow rate was 2.5 L/min. Pall rings were used as the structured packing materials, with a specific surface area of 320 m²/m³ and the quantity used in the column resulted in a contacting surface area of 0.49 m². In order to obtain FIG. 3, four alternative capture solutions were tested as CO₂ absorbers, using a packed column gas-liquid contactor for absorbing CO₂ from air. The amount of absorbed CO₂ was then determined by degassing the modified capture solutions after the capture step. The four capture solutions tested were:
0.5M K₂CO₃ in 7% MEA (aq)
0.5M K₂CO₃ in 10% AMP (aq)
0.5M K₂CO₃ in 13% MDEA (aq)
0.5M K₂CO₃ (aq)

As shown in FIG. 3, the three amine-containing capture solutions according to the present invention performed far better than the 0.5M K₂CO₃ amine-free solution. MEA was found to be the amine that absorbed the most CO₂, followed by AMP and then MDEA.

In terms of capture rates, testing established that primary amine (MEA)>sterically hindered primary amine (AMP)>tertiary amine (MDEA)>no amine.

The CO₂ absorption promotion effects of four capture solutions are set out in Table 2 below.

TABLE 2
A table comparing the “promotion” effect of different amines versus K₂CO₃
Table 2: Promotion effects of the different amines trialled vs baseline K2CO3

| | | | | Delta CO2 Normalised to |
|---|---|---|---|---|
| | | | | Carbonate i.e., |
| | | | Average Steady State CO2 | Amine Promotion |
| Apparatus | Solution Volume | Solution | Delta (ppm) | Factor |
| Packed Column | 2L | 0.5M K2CO3 | 58.76 | 1.00 |
| Packed Column | 2L | 0.5M K2CO3 + 10.3 wt % AMP | 246.45 | 4.19 |
| Packed Column | 2L | 0.5M K2CO3 + 13 wt % MDEA | 170.81 | 2.91 |
| Packed Column | 2L | 0.5M K2CO3 + 7 wt % MEA | 479.95 | 8.17* |

Compared to a solution of potassium carbonate not containing any amine, the amine-containing capture solutions of the present invention can be seen to be multiple times more effective at capturing CO₂.

FIG. 4 is a plot comparing the capture flux of CO₂ into the different capture solutions and pH across time. For experimental practicality, the solution was sparged with pure CO₂ at short intervals in order to progress through the loading capacity of the solvent. This is clearly indicated where there are either gaps or sudden changes in pH. The capture flux was calculated in real-time using on-line infrared sensors on the inlet and outlet of the packed column.

The experiments show that both MEA and PEI exhibit the highest capture fluxes across the pH range while AMP exhibited lower capture fluxes. For example, comparison around pH 10.5 shows that MEA retains the highest capture fluxes.

Just FIG. 5a is a diagram comparing the power consumption (PC) of different capture solutions usable in the present invention, while FIG. 5b shows the current efficiency (CE) for the same experiments. These charts compare the energetic requirements of performing the method of the present invention using different amine promoted carbonate capture solutions. Three different amine-promoted carbonate capture solvents were tested, in addition to one amine-free solution of KHCO₃/K₂CO₃. Solutions were prepared to simulate the capture solvents that would be received from a contactor and the capture solution was subjected to electrodialysis in a bipolar membrane electrodialysis cell containing 20 BPM-AEM membrane pairs, at a current density of 120 A/m². A release solution of 1M KH₂PO₄ was used for all tests.

The outcome of this experiment was that, of the capture solutions investigated, the PEI-containing capture solution was found to be the most energy-efficient amine for CO₂ regeneration. The present inventors theorise that PEI is better at bicarbonate formation due to the presence of primary, secondary and tertiary amines. The carbamates are thought to be very hindered due to the PEI polymeric chain and the tertiary amine can react with carbamate to form bicarbonate via an intramolecular reaction mechanism.

FIG. 5b shows the current efficiency of each solution tested, the maximum theoretical capture efficiency of a carbonate solution is 50%, whereas the maximum theoretical capture efficiency of a bicarbonate solution is 100%. It can be seen that all capture solutions yielded efficiencies of greater than 50%, in particular the amines solutions exhibited greater current efficiencies than the KHCO₃/K₂CO₃ comparison. Most noteworthy was that the PEI-based capture solution achieved current efficiencies in excess of 90% demonstrating that promoted carbonate solvents can be utilised both for increased capture rates and for improving the efficiency of bipolar-membrane electrodialysis.

FIG. 6a compares the power consumption and current efficiency of the method of the present invention at different current densities, while FIG. 6b compares the power consumption at different capture pH values.

In this experiment:
the BPMED cell contained 20 BPM-AEM pairs;
capture solution: MEA+1M K₂CO₃;
release solution: 1M KH₂PO₄

The results of FIGS. 6a and 6b showed that as current densities decrease, the power consumption of the capture and release process also decreases.

As the capture pH increases, power consumption also increases, and current efficiencies decrease. At high pH, [HCO₃]<< [CO₃²⁻].

FIGS. 7a and 7b show a comparison of the power consumption and current efficiency of different amine-promoted carbonate capture solutions at different current densities. The MEA-containing capture solution was tested twice at the same current density of 278 A/m², but on one of these tests the pH of the release stream was reduced to pH 4.

These tests confirmed that as the pH of the release stream decreases, the power consumption of the capture and release process also decreases, this is evidenced in FIG. 9a whereby different release solutions were investigated and the release stream pH was monitored.

Of the three amine-containing capture solutions tested, PEI achieved the lowest power consumption and highest current efficiencies. Each of these capture solutions were tested at the same pH. The greater current efficiencies exhibited by PEI suggest that there is either more bicarbonate in solution or the presence of the molecule assists the selective transport of bicarbonate across the anion-exchange membrane.

The higher power consumptions at higher current densities partially result from the formation of CO₂ bubbles within the BPMED membrane stack. In order to avoid this phenomenon, the release stream may be pressurised to prevent evolution of CO₂ gas within the cell, or lower current densities may be used.

FIG. 8a is a graph of CO₂ released by three different release solutions usable in the present invention. CO₂ (g) released was charted as a function of time. In this experiment, the BPMED stack was fitted with 5 membrane pairs and applied current was set at 1 A (278 A/m²). The initial (pre-CO₂ dissolution) capture solution consisted of 0.33 M KHCO₃ and 0.33 M K₂CO₃. Three different release solutions were tested: a mixture of 0.0825 M KHCO₃ and 0.0825 M K₂CO₃; 0.125 K₂SO₄ and 0.25 M NaH₂PO₄. In all cases throughout this document, the capture and release solution compositions specified are those of the initial (pre-CO₂ dissolution) solution, as once the process has begun, the formation of carbonate and bicarbonate anions will alter the composition. Both initial capture and release solution volumes were 0.55 L while the flow rate for both solutions was set at 15 L/h. Electrode solution was made of 0.5M K₂SO₄ with a volume of 0.75 L while the flow rate was set at 27.5 L/h.

Both K₂SO₄ and NaH₂PO₄-containing release solutions were seen to product comparably high quantities of evolved CO₂ after around 10 minutes, with the KHCO₃/K₂CO₃ mixture performed by far the worst of the three, and produced much lower quantities of CO₂ over the course of the experiment—this can be explain by the consumption of protons by the carbonate species. Of the three release solutions tested, the phosphate-containing release solution was the best-performing.

FIGS. 8b and 8c are graphs comparing current efficiency and power consumption for the three different release solutions tested in FIG. 8a, using the same experimental set-up described for FIG. 8a.

The current efficiency results for the three release solutions mirrored the CO₂ production results shown in FIG. 8a. The phosphate release solution required the lowest power consumption, closely followed by the sulphate release solution, while the power consumption of the KHCO₃/K₂CO₃ mixture was the highest of the three release solutions tested.

From these results, the phosphate-based release solution was found to be the best option for use in the method of the present invention over the investigated timescales.

FIGS. 9a and 9b plot pH as a function of the time for: the release solution (FIG. 10a); and the capture solution (FIG. 10b). The ED stack was fitted with 5 membrane pairs and applied current was set at 1 A (278 A/m²). Results shown for initial capture solution of 0.33 M KHCO₃ and 0.33 M K₂CO₃ and for initial release solution of 0.0825 M KHCO₃ and 0.0825 M K₂CO₃, 0.125 K₂SO₄ and 0.25 M NaH₂PO₄ respectively. Both initial capture and release solution volumes were 0.55 L while the flow rate for both solutions was set at 15 L/h. Electrode solution was made of 0.5M K₂SO₄ with a volume of 0.75 L while the flow rate was set at 27.5 L/h.

Release pH in FIG. 9b is shown to rise because this was a batch experiment and so the concentration bicarbonate is decreasing over the course of the experiment and being replaced with OH. The results of FIGS. 9a and 9b show the difference in pH of the release stream, and indicate that the more acidic release streams seem to perform better. The improved performance is thought to result from a lower concentration of bicarbonate in the release stream due to the equilibrium of CO₂ in solution favours CO₂ over bicarbonate in acidic regimes, a low concentration of bicarbonate should reduce bicarbonate back-diffusion into the capture solution which is a parasitic loss to the current efficiency.

FIGS. 10a and 10b compares the current efficiency and power consumption when carrying out the same process using an amine-containing capture solution according to the invention, with the same process using an amine-free capture solution. The results shown relate to initial capture solutions of 0.33 M KHCO₃ and 0.33 M K₂CO₃ with and without 10.3 w % AMP and of 0.66 M KHCO₃ and 0.66 M K₂CO₃ with and without 10.3 w % AMP. The initial release solutions were 0.25 M KH₂PO₄ for the initial capture solutions with a 1 M total potassium concentration and 0.5M KH₂PO₄ for the initial capture solutions having a total potassium concentration of 2 M respectively. Electrode solution was made of a 0.5 M K₂SO₄ solution. All initial capture, release and electrode comportment volume were filled with 1 L. The flow rates for both capture and release solutions were set at 37.5 L/h. and at 27.5 L/h for the electrode compartment.

This test confirmed that the presence of AMP in the capture solution leads to higher current efficiencies and better or comparable power consumptions. Furthermore this performance was maintained for a longer period of time at constant-current conditions, indicating that the performance is less sensitive to the concentration of bicarbonate and carbonate in solution. The amine-containing capture solution demonstrated a power consumption of only 1900 kWh/tonne_{CO2}, despite the experimental setup being unoptimized and containing only 5 membrane pairs. It was observed that AMP decreased the conductivity of the capture solution which although increased the voltage and energy consumption, was offset by the increase in current efficiency.

FIG. 11 shows an overlay of the “capture flux” from the air contactor using an MEA-promoted capture solvent, and the “release flux” from the bipolar membrane electrodialysis stack. These results show that between pH 10.9-11.05, the rates of capture and release can be conducted at approximately 80% of their maximum respective rates for this particular system. The optimum pH will vary depending on performance of the particular chosen capture solvent and bipolar-membrane electrodialysis stack design.

### Electrodialysis Methodology

### Amine Solution Make Up:

The concentrated amine solution was weighed inside of a fumehood (FH) and dissolved in DI water to make the solution up to x wt % (the wt % was determined by having equal N groups in the structures of different amines, based on a 5 wt % PEI solution). The container was covered and inverted several times/mixed to ensure dissolution of the concentrated amine solution.

Inside of a FH, CO₂ was bubbled through the solution at low flows by means of a sparger connected to a CO₂ canister. To ensure oversaturation of the solution, a pH of 8.5 was reached. The CO₂-saturated solution was decanted into a tri-neck round bottom flask (RBF).

A condenser tube was fitted to one neck, which was recirculated with cold water by means of a peristaltic pump and a chiller. A ground glass joint bent inlet adaptor was fitted to another neck and connected to an air pump by means of silicon tubing to continuously bubble air through the solution. A stopper was connected to the third neck. All connections and adaptors were sealed using silicon grease.

The solution was left under magnetic stirring until the pH had stabilised, indicating the equilibration of CO₂ in solution and the CO₂ in the headspace (i.e. Henry's law is satisfied and the concentration of CO₂ in solution is directly proportional to the partial pressure exerted by the gas in the headspace directly above the liquid. This method was followed when first comparing the amine solutions to make their treatment identical.

For ED experiments using CO₂-containing amine solutions, the procedure above was followed except the equilibration step was skipped and the target pH was that decided by the equilibration experiment above.

Amine Solution Make Up with KHCO₃/K₂CO₃:

The concentrated amine solution was weighed inside of a FH and dissolved in DI water to make the solution up to x wt % (the wt % was determined by having equal N groups in the structures of different amines, based on a 5 wt % PEI solution). The container was covered and inverted several times/mixed to ensure dissolution of the concentrated amine solution.

Inside of a FH, CO₂ was bubbled at low flows through the solution by means of a sparger connected to a CO₂ canister. After the target pH, determined by the equilibration experiment for the specific amine, was reached, KHCO₃/K₂CO₃ at various molar quantities were added and dissolved.

Amine and K₂CO₃ Sparged to pH 10.5:

The concentrated amine solution was weighed inside of a FH and dissolved in DI water to make the solution up to x wt % (the wt % was determined by having equal N groups in the structures of different amines, based on a 5 wt % PEI solution). The container was covered and inverted several times/mixed to ensure dissolution of the concentrated amine solution. 1M K₂CO₃ was added to replicate the exact capture solution that was used for testing in air contacting. Inside of a FH, CO₂ was bubbled at low flows through the solution by means of a sparger connected to a CO₂ canister until a solution pH of 10.5 was reached.

### Cell Stack Assembly:

The membranes ordered were cut by hand to fit the cell stack using a homemade cutting template and 5 mm diameter medical punching tools. The spacers arrived pre-cut. The cathode-side of the cell stack was left facing down and 4 mm steel rods were placed into the solution inlet holes to guide the placement of the membranes. End spacers were placed before and after the first and last membrane of the stack.

The stack was capped with BPMs. The BPMs were faced CEM-side-down to avoid irreversible delamination/ballooning of the membrane as a result of operating under forward bias conditions. The spacers were flipped in an alternating fashion to prevent mixing of the capture and release compartments. Two spacers per membrane were used to prevent large pressure drops and low flow across the stack.

Once the membranes were placed on the stack, the guiding rods were removed and the anode side of the cell stack was placed on top. The cell stack was sealed using a torque meter set to 5 N.m. The stack was reconnected to the test stand by means of push valves. The test stand operates in batch mode rather than continuous.

The ERS flowed from the cathode side of the cell first to the anode in order to prevent oxygen oxidation to peroxide and preferential flow over one electrode to the other.

When not in use, the cell stack was cleaned thoroughly by flowing DI water through the test stand. The capture, release and ERS tanks were emptied and the waste solutions disposed of as required. The tanks were flushed with DI water separately. For extended periods of time, the solution tanks were filled with a 1.5 wt % NaCl solution which was periodically circulated around the tank to prevent biological degradation of the membranes.

Testing within the Stack:

The capture release and ERS compartments were filled with 1 L each of the appropriate solutions. The pumps were turned on to flow rates specific to the number of cell pairs within the stack. The current efficiency is determined by Equation (1):

$$Current Efficiency = zFQC / NI \qquad ( 1 )$$

Q is the flow rate (L·s⁻¹), N is the number of membrane pairs, I is the current (A), Z is the stoichiometry of the ion being transported, F is the Faraday constant (A·s·mol⁻¹), C is the concentration of the ion being transported (mol·L⁻¹) and CE is the current efficiency. For the BPM-AEM-BPM configuration, it was assumed that the only ion being transported was HCO₃⁻, yet in reality, a combination of HCO₃⁻ and CO₃²⁻ ions will have been actively crossing the AEM.

Sufficient time was left for the stabilisation of conductivity and pH values before the power supply was turned on. A voltage ceiling was applied such that the maximum voltage did not exceed 3V per membrane pair so as not to degrade the membranes under extreme operating conditions.

To obtain a current-voltage plot, the current was varied from 0.2-2 A. Some time was left for the voltage value to stabilise before recording the value.

Once the current voltage plot was collected, the power supply and pumps were turned off and the capture and release solution compartments were emptied and refilled with the appropriate solution.

As before, the pumps were turned on and sufficient time was left for pH and conductivity values to stabilise before turning the power supply on. The same voltage ceiling was applied and a current was set. The experiment was left running for an hour before cleaning the stack.

### Amine Immobilisation Methodology

It is possible to immobilise the amine promoter in an amine functionalised surface in a number of ways. Any of these methods are suitable for use in the present invention. Exemplary methods for amine immobilisation are set out below.

### Direct Modification of Polyvinyl Chloride (PVC)

PVC may be used as packing material within the system used by the invention. The chlorine atoms on the PVC can be substituted with an amine-containing compound to provide an amine functionalised surface, as demonstrated by the following examples:

a. Substitution of Cl with an Amine-Containing Thiol

As shown in scheme 1, the PVC was reacted with 4-aminothiophenol to provide a PVC surface functionalised with —NH₂ groups in accordance with the methodology as set out in McCoy et al, Eur. Polym. J., 2017, 97, 40-48.

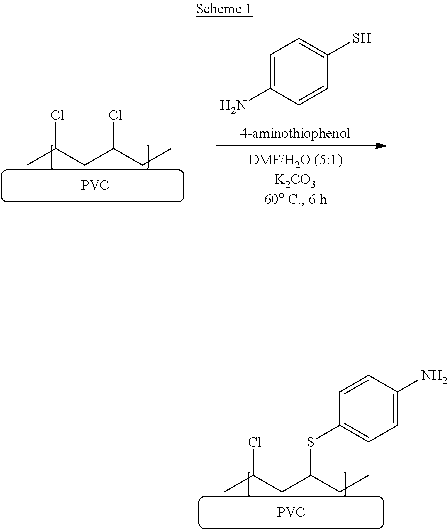

It will be appreciated that other amine containing thiols (e.g. amine-containing aromatic thiols) may be used in place of 4-aminothiophenol in the present invention.

b. Substitution of Cl with an Amine

As shown in scheme 2, the PCV was reacted with various amines in the presence of a MEK (methyl ethyl ketone) solvent to provide a PCV surface functionalised with amine groups in accordance with the methodology as set out in J. Mater. Chem. A, 2017, 5, 11864-11872.

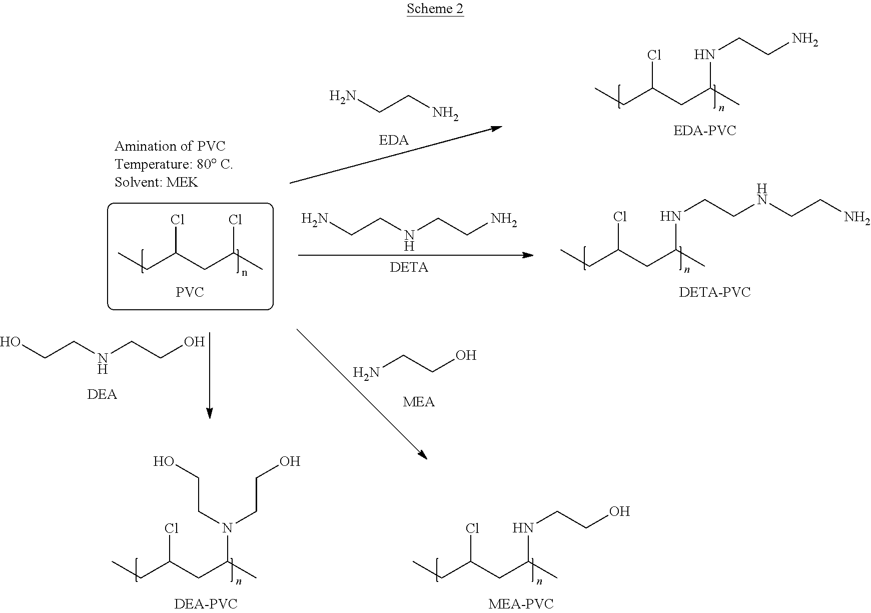

In this scheme, EDA=ethylenediamine, DETA=diethylenetriamine, MEA=monoethanolamine, DEA=diethanolamine.

It will also be appreciated that other amines, such as TEPA (tetraethylenepentamine) can be used in this reaction.

### Using Amine-Functionalised Silica Gel

Another way of incorporating an amine-functionalised surface into the method of the invention is to use amine-functionalised silica gel. Silica gel functionalised with various amines is commercially available from Sigma Aldrich. The amine-functionalised silica gel can be used in a variety of different ways, for example by coating any surface between the area in which the gas contacts the capture solution and the basic compartment of the electrodialysis chamber. For example, the amine-functionalised silica gel may be used to coat a packing material.

A PVC packing material was functionalised with amino-functionalised silica gel (3-diethylenetriamino) propyl-functionalised silica gel, CAS number 1173022-96-2) purchased from Sigma Aldrich by dispersing the gel in water or ethanol, and contacting the packing material with the dispersion.

A PVC packing material was functionalised with amino-functionalised silica gel (3-diethylenetriamino) propyl-functionalised silica gel, CAS number 1173022-96-2) purchased from Sigma Aldrich by spraying the packing material with methyl ethyl ketone (MEK). The MEK softens the PVC surface through partial dissolution to provide an adhesive surface, and contacting the adhesive surface with the gel.

1. A method of capturing CO₂ from a gas mixture comprising the steps of:
transferring CO₂ from the gas mixture into a capture solution to form a modified capture solution comprising bicarbonate ions;
performing electrodialysis on the modified capture solution using a bipolar membrane electrodialysis system, to transfer bicarbonate ions into a release solution and regenerate the capture solution;
wherein the capture solution comprises a metal carbonate, and wherein the capture solution contacts a promoter which accelerates the transfer of CO₂ into the capture solution,
wherein the promoter is immobilized on a promoter-functionalized surface, and wherein:
a. the capture solution is in contact with the promoter-functionalized surface during the step of contacting the gas mixture with the capture solution, or
b. the capture solution contacts the promoter-functionalized surface after the step of contacting the gas mixture with the promoter.

2. A method according to claim 1, in which the promoter is an amine.

3. A method according to claim 1, in which the gas mixture is air, and the method is a method of direct air capture (DAC) of CO₂ from air.

4. A method according to claim 1, wherein the promoter comprises an amine, an amino acid, piperazine or a derivative thereof, piperidine or a derivative thereof.

5. A method according to claim 2, in which the amine has a carbamate stability constant, log K_{c}, of less than 1.9 at 298.15 K and/or in which the amine has an amine protonation constant, pKa, of greater than 9.6 at 298.15 K.

6. (canceled)

7. (canceled)

8. (canceled)

9. A method according to claim 2, in which the amine is a primary amine, a secondary amine or a tertiary amine.

10. A method according to claim 7, in which the amine is monoethanolamine (MEA), 2-amino-2-methyl-1-propanol (AMP) or N-methyldiethanolamine (MDEA).

11. (canceled)

12. (canceled)

13. (canceled)

14. (canceled)

15. A method according to claim 2, in which the amine in the capture solution is selected from the list: Monoethanolamine (MEA); N-methyldiethanolamine (MDEA); 2-amino-2-methyl-1-propanol (AMP); 2-amino-1-propanol (AP); 3-amino-1-propanol (MPA); Diethanolamine (DEA); Piperazine (PZ); 2-(isopropylamino) ethanol (IPAE); Ethylenediamine (EDA); Propylamine; 3-piperidinemethanol (3PM); 2-methyl propanamine; 2-amino-2-methyl-1,3-propanediol (AMPD); 2-amino-2-methyl-1,3-propanediol (AEPD); 2-(methylamino) ethanol (MMEA); Piperidine; Triethanolamine (TEA); 4-amino-1-butanol (4A1B); 5-amino-1-pentanol (5A1PM); Isobutylamine (IBA); and 1-(2-aminoethyl) piperazine (AEP).

16. A method according to claim 2, in which the amine is a cationic polymer having a repeat unit which comprises a plurality of amine groups.

17. A method according to claim 2, in which the amine is a polymeric amine.

18. A method according to claim 2, in which the amine is polyethyleneimine (PEI).

19. A method according to claim 2, wherein the capture solution contains up to 15 wt % amine.

20. A method according to claim 1, in which the metal carbonate is an alkali metal carbonate.

21. (canceled)

22. A method according claim 1, in which after the step of contacting the gas mixture with the capture solution, and before the step of performing electrodialysis on the modified capture solution, the modified capture solution has a pH of between 9.5 and 10.5 and/or in which the capture solution is maintained between pH 11.5 and pH 9.5, as CO₂ is dissolved and released during electrodialysis.

23. (canceled)

24. A method according to claim 1, in which the bipolar membrane electrodialysis system comprises an anion-exchange membrane, and is configured to transfer bicarbonate ions through the anion exchange membrane into the release solution.

25. A method according to claim 1, in which the bipolar membrane electrodialysis system comprises a monovalent-selective anion-exchange membrane.

26. A method according to claim 1, in which the bipolar membrane electrodialysis system comprises an ion-exchange resin configured to bind bicarbonate anions in the modified capture solution.

27. A method according to claim 1, in which the release solution comprises phosphate anions.

28. A method according to claim 1, in which the release solution comprises an alkali metal phosphate, or in which the release solution comprises K₂SO₄, or KHCO₃/K₂CO₃.

29. (canceled)

30. A method according to claim 1, in which, following the step of transferring bicarbonate ions into the release solution, the release solution has a pH of pH 6 or less.

31. (canceled)

32. A method according to claim 1, wherein the promoter-functionalized surface is a surface in a gas-liquid contactor, or a surface of a promoter-functionalized sorbent.

33. A method according to claim 17, wherein the polymeric amine is a cationic polymeric amine.

34. A method according to claim 33, wherein the capture species comprises a plurality of polymer resin particles functionalized with cationic functional groups, or in which the capture species comprises a slurry of anion-exchange resin particles functionalized with cationic functional groups.
